(19) United States
(12) Patent Application Publication
(10) Pub. No.: US 2017/0292780 A1
(43) Pub. Date: Oct. 12, 2017

(54) Refrigerator Appliance and a Method for Operating a Refrigerator Appliance

(71) Applicant: General Electric Company, Schenectady, NY (US)

(72) Inventor: Jianwu Li, Louisville, KY (US)

(21) Appl. No.: 15/093,815

(22) Filed: Apr. 8, 2016

(51) Int. Cl. F25D 29/00; G06F 3/041; F25D 21/00; G05B 19/048; F25D 11/02; F25C 1/14

(52) U.S. Cl. CPC F25D 29/005; F25D 11/02; F25C 1/147; F25D 21/002; G05B 19/048; G06F 3/041; F25D 2400/361; G05B 2219/2654

(57) ABSTRACT

A method for operating a refrigerator appliance includes receiving a user inquiry signal at a controller of the refrigerator appliance in response to an inquiry input at a user interface of the refrigerator appliance, obtaining a status of at least one operable component of the refrigerator appliance with the controller of the refrigerator appliance, and sending the status of the at least one operable component of the refrigerator appliance from the controller of the refrigerator appliance to the user interface of the refrigerator appliance. A related refrigerator appliance is provided.

### FIELD OF THE INVENTION

The present subject matter relates generally to refrigerator appliances.

### BACKGROUND OF THE INVENTION

Refrigerator appliances include various components that assist with cooling a chamber and/or regulating cooling of the chamber. For example, a sealed system may compress refrigerant in order to chill an evaporator and generate chilled air within the chamber. As another example, a fan may circulate the chilled air within the chamber in order to facilitate uniform cooling of the chamber. While necessary for their important function, such components can be noisy while operating.

Recent refrigerator appliances have numerous cycles that generate distinct noises. During the various cycles, the refrigerator appliance can emit noises unfamiliar to consumers. In response to unfamiliar noises, consumers frequently contact customer service to inquire about the noises. Such service requests are frequently unnecessary because the refrigerator appliance is operating normally despite the unfamiliar noises.

Accordingly, a refrigerator appliance with features for informing a user regarding an operating status of the refrigerator appliance would be useful. In particular, a refrigerator appliance with features for informing a user regarding whether the refrigerator appliance is operating normally or malfunctioning would be useful.

### BRIEF DESCRIPTION OF THE INVENTION

The present subject matter provides a method for operating a refrigerator appliance. The method includes receiving a user inquiry signal at a controller of the refrigerator appliance in response to an inquiry input at a user interface of the refrigerator appliance, obtaining a status of at least one operable component of the refrigerator appliance with the controller of the refrigerator appliance, and sending the status of the at least one operable component of the refrigerator appliance from the controller of the refrigerator appliance to the user interface of the refrigerator appliance after the inquiry input at the user interface of the refrigerator appliance. A related refrigerator appliance is provided. Additional aspects and advantages of the invention will be set forth in part in the following description, or may be apparent from the description, or may be learned through practice of the invention.

In a first exemplary embodiment, a method for operating a refrigerator appliance is provided. The method includes receiving a user inquiry signal at a controller of the refrigerator appliance in response to an inquiry input at a user interface of the refrigerator appliance and obtaining a status of at least one operable component of the refrigerator appliance with the controller of the refrigerator appliance. The at least one operable component of the refrigerator appliance is in operable communication with the controller of the refrigerator appliance. The method also includes sending the status of the at least one operable component of the refrigerator appliance from the controller of the refrigerator appliance to the user interface of the refrigerator appliance.

In a second exemplary embodiment, a refrigerator appliance is provided. The refrigerator appliance includes a cabinet that defines a chilled chamber. A first user interface is mounted to the cabinet, and a second user interface is disposed remotely relative to the cabinet. A controller is in operative communication with the first and second user interfaces. The controller includes a processor and a memory storing computer-executable instructions that, when executed by the processor, cause the processor to perform operations. The operations include obtaining a status of at least one operable component of the refrigerator appliance in response to receiving a user inquiry signal from the first user interface or the second user interface and sending the status of the at least one operable component of the refrigerator appliance to at least one of the first user interface or the second user interface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to an exemplary embodiment of the present subject matter.

FIG. 2 provides a front view of the refrigerator appliance of FIG. 1 with refrigerator doors of the refrigerator appliance shown in an open configuration to reveal a fresh food chamber of the refrigerator appliance.

FIG. 3 provides a schematic view of certain components of the exemplary refrigerator appliance of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

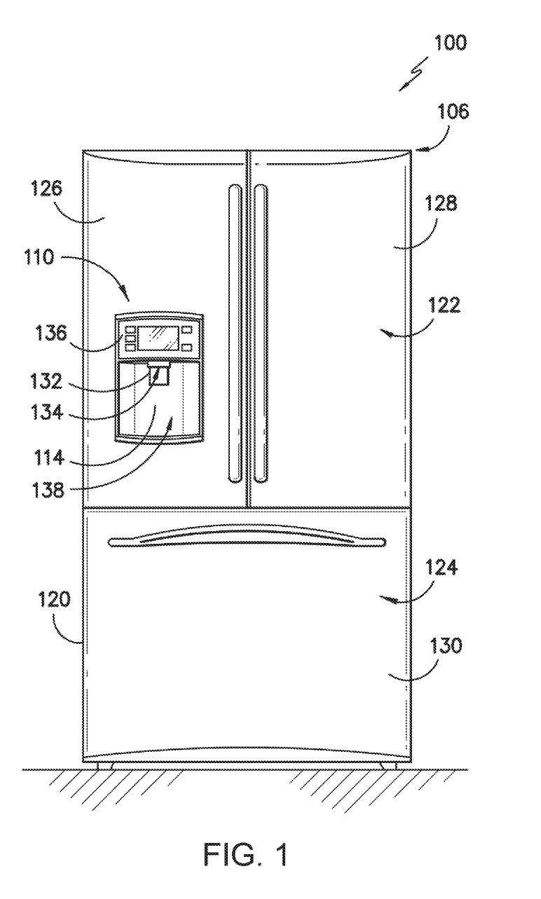

FIG. 1 is a front view of an exemplary embodiment of a refrigerator appliance 100. Refrigerator appliance 100 includes a cabinet or housing 120 that defines chilled chambers for storing food items therein. In particular, housing 120 defines an upper fresh food chamber 122 and a lower freezer chamber 124 arranged below the fresh food chamber 122. As such, refrigerator appliance 100 is generally referred to as a “bottom mount refrigerator appliance.” In the exemplary embodiment, housing 120 also defines a mechanical compartment (not shown) for receipt of a sealed cooling system. Using the teachings disclosed herein, one of skill in the art will understand that the present subject matter may be used with other types of refrigerators (e.g., side-by-sides or top mount). Consequently, the description set forth herein is for illustrative purposes only and is not intended to limit the present subject matter to any particular chilled chamber arrangement.

Refrigerator doors 126, 128 are rotatably hinged to an edge of housing 120 for accessing fresh food compartment 122. A freezer door 130 is arranged below refrigerator doors 126, 128 for accessing freezer chamber 124. In the exemplary embodiment, freezer door 130 is coupled to a freezer drawer (not shown) slidably mounted within freezer chamber 124.

Refrigerator appliance 100 includes a dispensing assembly 110 for dispensing water and/or ice. Dispensing assembly 110 includes a dispenser 114 positioned on an exterior portion of refrigerator appliance 100. Dispenser 114 includes a discharging outlet 134 for accessing ice and water. An activation member 132 is mounted below discharging outlet 134 for operating dispenser 114. In FIG. 1, activation member 132 is shown as a paddle. However, activation member 132 may be any other suitable mechanism for signaling or indication initiating a flow of ice and/or water into a container within dispenser 114, e.g., a switch or button. A user interface panel 136 is provided for controlling the mode of operation. For example, user interface panel 136 includes a water dispensing button (not labeled) and an ice-dispensing button (not labeled) for selecting a desired mode of operation such as crushed or non-crushed ice.

Discharging outlet 134 and activation member 132 are an external part of dispenser 114, and are mounted in a recessed portion 138 defined in an outside surface of refrigerator door 126. Recessed portion 138 is positioned at a predetermined elevation convenient for a user to access ice or water and enabling the user to access ice without the need to bend-over and without the need to access freezer chamber 124. In the exemplary embodiment, recessed portion 138 is positioned at a level that approximates the chest level of a user.

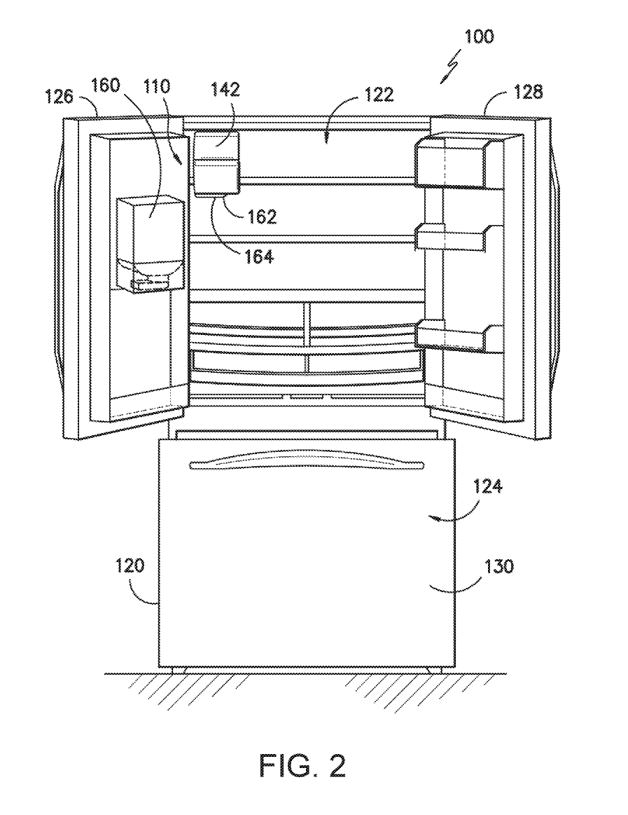

FIG. 2 is a perspective view of refrigerator appliance 100 having refrigerator doors 126, 128 in an open position to reveal the interior of the fresh food chamber 122. As such, certain components of dispensing assembly 110 are illustrated. Dispensing assembly 110 includes an insulated housing 142 mounted within refrigerator chamber 122. Due to insulation surrounding insulated housing 142, the temperature within insulated housing 142 can be maintained at levels different from the ambient temperature in the surrounding fresh food chamber 122.

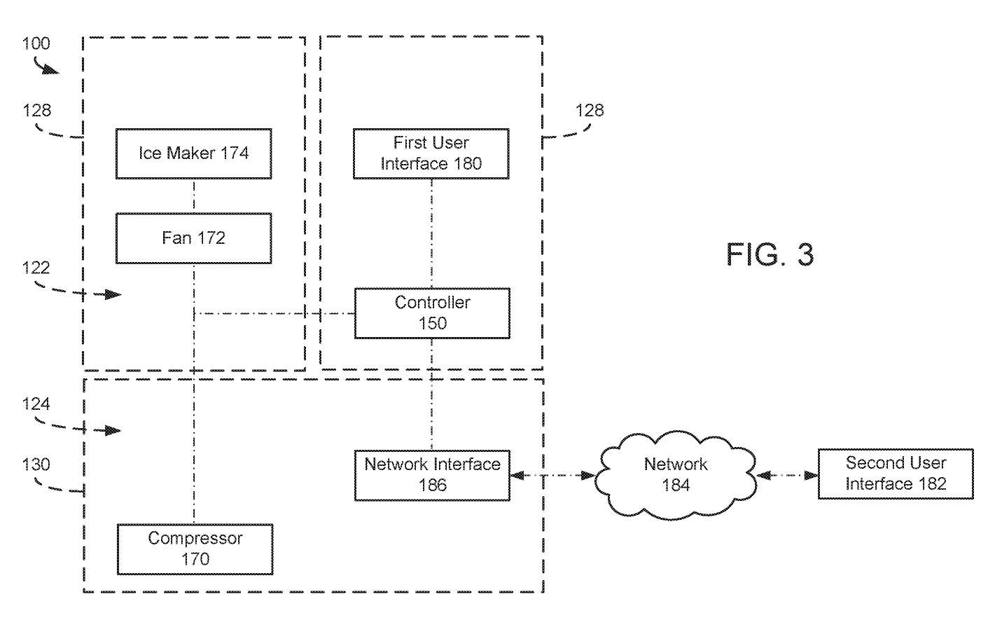

In particular, insulated cavity 142 is constructed and arranged to operate at a temperature that facilitates producing and storing ice. More particularly, the insulated cavity contains an icemaker 174 (shown in FIG. 3) for creating ice and feeding the same to a receptacle 160 that is mounted on refrigerator door 126. As illustrated in FIG. 2, receptacle 160 is placed at a vertical position on refrigerator door 126 that will allow for the receipt of ice from a discharge opening 162 located along a bottom edge 164 of insulated housing 142 when refrigerator door 126 is in a closed position (shown in FIG. 1). As door 126 is closed or opened, receptacle 160 is moved in and out of position under insulated housing 142.

Alternatively, in another exemplary embodiment of the present subject matter, insulated housing 142 and icemaker 174 can both be positioned directly on door 126. In still another exemplary embodiment of the present subject matter, in a configuration where the fresh food compartment and the freezer compartment are located side by side (as opposed to over and under as shown in FIGS. 1 and 2), icemaker 174 may be located on the door for the freezer compartment and directly over receptacle 160. As such, the use of an insulated housing would be unnecessary. Other configurations for the location of receptacle 160, icemaker 174, and/or insulated housing 142 may be used as well.

FIG. 3 provides a schematic view of certain components of refrigerator appliance 100. As may be seen in FIG. 3, refrigerator appliance 100 includes a computing device or controller 150. Controller 150 is operatively coupled or in communication with various components of a refrigeration system (not shown) of refrigerator appliance 100 that is configured for cooling fresh food chamber 122 and/or freezer chamber 124. The components include a compressor 170, an evaporator (not shown), a condenser (not shown), etc. Controller 150 can selectively operate compressor 170 in order to supply refrigerant to the evaporator and the condenser of the refrigeration system and cool fresh food chamber 122 and/or freezer chamber 124.

Controller 150 may be positioned in a variety of locations throughout refrigerator appliance 100. For example, as shown in FIG. 3, controller 150 may be disposed in one of refrigerator doors 128. Input/output (“I/O”) signals may be routed between controller 150 and various operational components of refrigerator appliance 100. The components of refrigerator appliance 100 may be in communication with controller 150 via one or more signal lines or shared communication busses.

Controller 150 is also in operative communication with an air handler or fan 172 and an icemaker 174. Thus, controller 150 may regulate operation of fan 172 and icemaker 174. In particular, controller 150 may selectively operate motors of fan 172 and icemaker 174 and/or a fill valve of icemaker 174.

Refrigerator appliance 100 also includes a first user interface 180, such as user interface panel 136 (FIG. 1). First user interface 180 may be mounted on refrigerator door 128 or at any other suitable location on refrigerator appliance 100. First user interface 180 is in communication with controller 150 such that first user interface 180 may receive signals from controller 150 corresponding to input commands from a user of refrigerator appliance 100. First user interface 180 may include, for example, a touchscreen interface.

Refrigerator appliance 100 also includes a network interface 186 that couples refrigerator appliance 100, e.g., controller 150, to a network 184 such that refrigerator appliance 100 can transmit and receive information over network 184. Network 184 can be any wired or wireless network such as a WAN, LAN, and/or HAN. Network interface 186 can include any circuitry or components for communication over network 184. For example, controller 150 can use network interface 186 to communicate with a second user interface 182. Network interface 186 may include transmitters, receivers, ports, controllers, antennas, or other suitable components for interfacing with network 184.

Refrigerator appliance 100, e.g., controller 150, is in communication with second user interface 182 via network 184. Second user interface 182 can be any device configured to communicate over network 184 and allow a user to remotely generate and transmit command signals to controller 150. For example, second user interface 182 may be a computer, a smartphone, a tablet, etc. Second user interface 182 is in communication with controller 150 such that second user interface 182 and controller 150 may transmit signals and data therebetween. Second user interface 182 can also include a network interface, e.g., constructed in the same or similar manner to network interface 186, that allows second user interface 182 to initiate communications with refrigerator appliance 100 over network 184.

Controller 150 can be any device that includes one or more processors and a memory. As an example, in some embodiments, controller 150 may be a single board computer (SBC). For example, controller 150 can be a single System-On-Chip (SOC). However, any form of controller 150 may also be used to perform the present subject matter. The processor(s) can be any suitable processing device, such as a microprocessor, microcontroller, integrated circuit, or other suitable processing devices or combinations thereof. The memory can include any suitable storage media, including, but not limited to, non-transitory computer-readable media, RAM, ROM, hard drives, flash drives, accessible databases, or other memory devices. The memory can store information accessible by processor(s), including instructions that can be executed by processor(s) to perform aspects of the present disclosure.

As an example, controller 150 may also include a number of modules to provide functionality or otherwise perform particular operations. It will be appreciated that the term “module” refers to computer logic utilized to provide desired functionality. Thus, a module can be implemented in hardware, application specific circuits, firmware and/or software controlling a general purpose processor. In one embodiment, modules are program code files stored on the storage device, loaded into memory and executed by a processor or can be provided from computer program products, for example computer executable instructions, that are stored in a tangible computer-readable storage medium such as RAM, hard disk or optical or magnetic media.

Various components of refrigerator appliance 100 emit noise during operation. For example, compressor 170, fan 172 and/or icemaker 174 frequently generate noise while operating. In particular, compressor 170 can generate noise while compressing refrigerant within the sealed system of refrigerator appliance, fan 172 can generate noise while circulating air across an evaporator or condenser of the sealed system, and icemaker 174 can generate noise while filling with water or harvesting ice. As another example, refrigerator appliance 100 may include a damper (not shown) that makes noise when shifting open or closed. The damper may be positioned between refrigerator chamber 122 and freezer chamber 124 to regulate air flow between refrigerator chamber 122 and freezer chamber 124.

The user of refrigerator appliance 100 may be unfamiliar with the noises generated during operation of refrigerator appliance 100. For example, during a pre-chill portion of a defrost operating cycle, such as the defrost operating cycles described in U.S. Pat. No. 6,772,597 of Zenter et al. and/or U.S. Patent Publication No. 2014/0123690 of Hanley et al., both of which are incorporated by reference in their entirety, controller 150 may operate compressor 170 and/or fan 172 at high speeds for an extended period of time at a beginning of the defrost cycle to cool the chilled chambers of refrigerator appliance 100 below a certain threshold and thereby provide a buffer that prevents overheating of the chilled chambers during the defrost cycle. When the user of refrigerator appliance 100 hears compressor 170 and/or fan 172 operating at such high speeds for relatively long periods of time, he or she may assume that refrigerator appliance 100 is malfunctioning and schedule a service call despite refrigerator appliance 100 operating normally. As another example, controller 150 may open a valve of icemaker 174, such as the valves described in U.S. Pat. No. 6,895,767 of Hu and/or U.S. Pat. No. 8,857,198 of Styn et al., both of which are incorporated by reference in their entirety, in order to fill icemaker 174 with liquid water for freezing to ice. When the user of refrigerator appliance 100 hears the valve of icemaker 174 opening or water flowing into icemaker 174, he or she may assume that refrigerator appliance 100 is malfunctioning and schedule a service call despite refrigerator appliance 100 operating normally. As yet another example, controller 150 may activate a rake or other ice harvester of icemaker 174 when the ice within icemaker 174 is fully formed. When the user of refrigerator appliance 100 hears the rake or other ice harvester of icemaker 174 in operation, he or she may assume that refrigerator appliance 100 is malfunctioning and schedule a service call despite refrigerator appliance 100 operating normally.

As discussed in greater detail below, refrigerator appliance 100 includes features for providing information to a user of refrigerator appliance 100 regarding the performance and/or operating status of refrigerator appliance 100. By apprising the user of the performance and/or operating status of refrigerator appliance 100, user satisfaction with refrigerator appliance 100 can be improved. In particular, service calls regarding refrigerator appliance 100 can be reduced by informing the user of the performance and/or operating status of refrigerator appliance 100. The features of refrigerator appliance 100 that communicate the performance and/or operating status of refrigerator appliance 100 are discussed in greater detail below.

When the user of refrigerator appliance 100 hears an unfamiliar or perplexing noise for refrigerator appliance 100 (or would otherwise like to know the status of the refrigerator appliance 100), the user utilizes first user interface 180 and/or second user interface 182 to generate a user inquiry signal. As an example, the user may actuate buttons or other inputs on first user interface 180 and/or second user interface 182 to generate the user inquiry signal. Controller 150 receives the user inquiry signal after the user engages first user interface 180 and/or second user interface 182.

After receiving the user inquiry signal, controller 150 obtains a status of at least one operable component of refrigerator appliance 100, where the at least one operable component of refrigerator appliance 100 is in operable communication with controller 150, e.g., such that controller 150 may selectively activate and deactivate each operable component. The operable components may include compressor 170, fan 172 and/or icemaker 174. The operable components may also include a damper or a valve. Controller 150 then sends the status of the at least one operable component to first user interface 180 and/or second user interface 182.

After receiving the status of the at least one operable component at first user interface 180 and/or second user interface 182, the status of the at least one operable component may be presented to the user of refrigerator appliance 100 on first user interface 180 and/or second user interface 182. Thus, the user may be informed of the current status of various operable components of refrigerator appliance 100, and the user may thereby know the source of the unfamiliar or perplexing noise emanating from refrigerator appliance 100, e.g., without having to schedule a service call.

To allow the user to know or determine the source of the unfamiliar or perplexing noise emanating from refrigerator appliance 100, the status of the at least one operable component may include an activation state, e.g., whether the operable component is on or off, for at least one of compressor 170, fan 172 or icemaker 174. Thus, controller 150 may determine whether compressor 170, fan 172 or icemaker 174 are active and operating in response to the user inquiry signal, and controller 150 may then send the current activation state of compressor 170, fan 172 or icemaker 174 to first user interface 180 and/or second user interface 182 where the user can see which of the components is active and/or operating. In certain exemplary embodiments, controller 150 may transmit the activation state for all of compressor 170, fan 172 or icemaker 174 to first user interface 180 and/or second user interface 182.

After receiving the user inquiry signal, controller 150 may also determine the current operating mode of refrigerator appliance 100 and send the current operating mode of refrigerator appliance 100 to first user interface 180 and/or second user interface 182. For example, refrigerator appliance 100 may include various operating modes including but not limited to, a chilled chamber cooling mode, a defrost mode, an icemaker fill mode, an icemaker harvest mode, an idle mode, an ice making mode or an ice maintenance mode. In the chilled chamber cooling mode, controller 150 activates compressor 170 such that the sealed system of refrigerator appliance 100 cools the chilled chambers to a set temperature. In the defrost mode, controller 150 activates a heating element adjacent the evaporator of the sealed system and/or directs relatively hot refrigerant through the evaporator in order to remove ice buildup from the evaporator. In the icemaker fill mode, controller 150 opens the valve of icemaker 174 such that liquid water flows into a mold body or auger housing of icemaker 174. In the icemaker harvest mode, controller 150 activates a heating element and/or a motor of icemaker 174 to remove ice from icemaker 174. In the idle mode, controller 150 deactivates all operable components of refrigerator appliance 100.

After receiving the current operating mode of refrigerator appliance 100 at first user interface 180 and/or second user interface 182, the current operating mode of refrigerator appliance 100 is presented to the user of refrigerator appliance 100 on first user interface 180 and/or second user interface 182. Thus, the user may be informed of the current operating mode of refrigerator appliance 100, and the user may thereby know the source of the unfamiliar or perplexing noise emanating from refrigerator appliance 100, e.g., without having to schedule a service call.

As discussed above, the user of refrigerator appliance 100 may be presented with the status of the at least one operable component and/or the current operating mode of refrigerator appliance 100 from controller 150 in response to the user inquiry signal and thereby determine why refrigerator appliance 100 is operating in a certain manner. In addition, the user may modify operation of refrigerator appliance 100. For example, the user may utilize first user interface 180 and/or second user interface 182 to generate a user termination signal. As an example, the user may actuate buttons or other inputs on first user interface 180 and/or second user interface 182 to generate the user termination signal. Controller 150 receives the user termination signal after the user engages first user interface 180 and/or second user interface 182.

After receiving the user termination signal, controller 150 may modify operation of refrigerator appliance 100. In particular, controller 150 terminates the current operating mode of refrigerator appliance 100 in response to receiving the user termination signal. Thus, controller 150 may deactivate compressor 170, fan 172 and/or icemaker 174 after receiving the user termination signal in order to terminate the current operating mode of refrigerator appliance 100. As a particular example, controller 150 may shift refrigerator appliance from the chilled chamber cooling mode, the defrost mode, the icemaker fill mode or the icemaker harvest mode to the idle mode in response to receiving the user termination signal. In such a manner, the user may adjust operation of refrigerator appliance 100 to stop the unfamiliar or perplexing noise emanating from refrigerator appliance 100.

If refrigerator appliance 100 is malfunctioning, controller 150 may generate an error, fault or function code corresponding to the particular malfunctioning (or potentially malfunctioning) component or system of refrigerator appliance 100. The error, fault or function codes can assist a service technician with quickly diagnosing issues within refrigerator appliance 100. Controller 150 may transmit or send the error, fault or function code to first user interface 180 and/or second user interface 182. Thus, the user may know of any active error, fault or function code for refrigerator appliance 100, e.g., and give the error, fault or function code to a service technician prior to the service technician travelling to service the refrigerator appliance 100. Similarly, controller 150 may transmit the status of the at least one operable component and/or the current operating mode of refrigerator appliance 100 to the service technician, e.g., to a computer and/or server of the service technician. Thus, the service technician may have greater knowledge of the operation of refrigerator appliance 100 prior to the service technician travelling to service the refrigerator appliance 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a refrigerator appliance, comprising:
receiving a user inquiry signal at a controller of the refrigerator appliance in response to an inquiry input at a user interface of the refrigerator appliance;
obtaining a status of at least one operable component of the refrigerator appliance with the controller of the refrigerator appliance, the at least one operable component of the refrigerator appliance being in operable communication with the controller of the refrigerator appliance; and
sending the status of the at least one operable component of the refrigerator appliance from the controller of the refrigerator appliance to the user interface of the refrigerator appliance.

2. The method of claim 1, wherein the user interface of the refrigerator appliance comprises a touchscreen interface mounted to the refrigerator appliance.

3. The method of claim 1, wherein the user interface of the refrigerator appliance comprises a smartphone that is remotely located from a cabinet of the refrigerator appliance and is in wireless communication with the controller of the refrigerator appliance.

4. The method of claim 1, wherein the status of the at least one operable component of the refrigerator appliance comprises an activation state for at least one of a fan, a compressor or an icemaker of the refrigerator appliance.

5. The method of claim 4, wherein the status of the at least one operable component of the refrigerator appliance comprises the activation state for each of the fan, the compressor and the icemaker of the refrigerator appliance, said step of sending comprising sending the activation state for each of the fan, the compressor and the icemaker of the refrigerator appliance from the controller of the refrigerator appliance to the user interface of the refrigerator appliance after the inquiry input at the user interface of the refrigerator appliance.

6. The method of claim 1, further comprising sending a current operating mode of the refrigerator appliance from the controller of the refrigerator appliance to the user interface of the refrigerator appliance after the inquiry input at the user interface of the refrigerator appliance.

7. The method of claim 6, further comprising:
receiving a user termination signal at the controller of the refrigerator appliance in response to a termination input at the user interface of the refrigerator appliance; and
terminating the current operating mode of the refrigerator appliance with the controller of the refrigerator appliance in response to receiving the user termination signal.

8. The method of claim 6, wherein the current operating mode of the refrigerator appliance comprises at least one of a chilled chamber cooling mode, a defrost mode, an icemaker fill mode, an icemaker harvest mode or an idle mode.

9. The method of claim 1, wherein said step of sending further comprises sending a fault code from the controller of the refrigerator appliance to the user interface of the refrigerator appliance after the inquiry input at the user interface of the refrigerator appliance.

10. The method of claim 1, further comprising transmitting at least one of the status of the at least one operable component of the refrigerator appliance or a fault code from the controller of the refrigerator appliance to a customer service server located remotely from the refrigerator appliance after the inquiry input at the user interface of the refrigerator appliance.

11. A refrigerator appliance, comprising:
a cabinet defining a chilled chamber;
a first user interface mounted to the cabinet;
a second user interface disposed remotely relative to the cabinet; and
a controller in operative communication with the first and second user interfaces, the controller comprising a processor and a memory storing computer-executable instructions that, when executed by the processor, cause the processor to perform operations, the operations comprising
obtaining a status of at least one operable component of the refrigerator appliance in response to receiving a user inquiry signal from the first user interface or the second user interface; and
sending the status of the at least one operable component of the refrigerator appliance to at least one of the first user interface or the second user interface.

12. The refrigerator appliance of claim 11, wherein the first user interface comprises a touchscreen interface mounted to a door of the cabinet.

13. The refrigerator appliance of claim 11, wherein the second user interface comprises a smartphone that is in wireless communication with the controller.

14. The refrigerator appliance of claim 11, further comprising a fan, a compressor and an icemaker disposed within the cabinet, the at least one operable component of the refrigerator appliance comprising the fan, the compressor and the icemaker.

15. The refrigerator appliance of claim 14, wherein the status of the at least one operable component of the refrigerator appliance comprises an activation state for each of the fan, the compressor and the icemaker of the refrigerator appliance.

16. The refrigerator appliance of claim 11, wherein the operations further comprise sending a current operating mode of the refrigerator appliance to at least one of the first user interface or the second user interface in response to receiving the user inquiry signal from the first user interface or the second user interface.

17. The refrigerator appliance of claim 16, wherein the operations further comprise terminating the current operating mode of the refrigerator appliance in response to receiving a user termination signal from the first user interface or the second user interface.

18. The refrigerator appliance of claim 16, wherein the current operating mode of the refrigerator appliance comprises at least one of a chilled chamber cooling mode, a defrost mode, an icemaker fill mode, an icemaker harvest mode or an idle mode.

19. The refrigerator appliance of claim 11, wherein the operations further comprise sending a fault code to the first user interface or the second user interface after receiving the user inquiry signal from the first user interface or the second user interface.

20. The refrigerator appliance of claim 11, wherein the operations further comprise transmitting at least one of the status of the at least one operable component of the refrigerator appliance or a fault code to a customer service server located remotely from the refrigerator appliance after receiving the user inquiry signal from the first user interface or the second user interface.
